(19) United States
(12) Patent Application Publication
(10) Pub. No.: US 2016/0243725 A1
(43) Pub. Date: Aug. 25, 2016

(54) METHOD AND DEVICE FOR WIRE CUTTING OF A MATERIAL

(71) Applicant: COMMISSARIAT A L'ENERGIE ATOMIQUE ET AUX ENERGIES ALTERNATIVES, Paris (FR)

(72) Inventors: Léo Sillard, Malakoff (FR); Jean-Paul Garandet, Le Bourget Du Lac (FR); Jean-Daniel Penot, Chambéry (FR)

(73) Assignee: COMMISSARIAT A L'ENERGIE ATOMIQUE ET AUX ENERGIES ALTERNATIVES, Paris (FR)

(21) Appl. No.: 15/023,902

(22) PCT Filed: Sep. 23, 2014
(86) PCT No.: PCT/EP2014/070267

§ 371 Date: Mar. 22, 2016

(30) Foreign Application Priority Data
Sep. 24, 2013 (FR) 1359194

(51) Int. Cl. B28D 5/00; G05B 19/418; B28D 5/04

(52) U.S. Cl. CPC B28D 5/0064; B28D 5/045; G05B 19/418; G05B 2219/45031; G05B 2219/50331

(57) ABSTRACT

The invention relates to a method for wire cutting of a material, wherein a cutting wire is advanced into the material by causing said wire to scroll in such a way as to progressively cut the material, the method being characterised in that it comprises: the measurement of a force applied by the wire on the material as a function of time, the measurement of the advancement of the wire in the material as a function of time, the determination, as a function of said force and said advancement of the wire, of a variable characterising the state of the wire cutting and, servo control of at least one cutting parameter through changes in said variable so as to reduce the rate of wear of the wire and/or to reduce the risk of breaking of the wire. The invention also relates to a device for wire cutting allowing implementation of said method.

### FIELD OF THE INVENTION

The present invention relates to a method and device for wire cutting a preferably fragile material.

### BACKGROUND OF THE INVENTION

Wire saws are used in many fields, from among which may be mentioned the cutting of semi-conducting materials (such as silicon) for forming substrates, the cutting of wood and the cutting of stone.

Wire saws consist of one or several free wires or in the form of a loop set into motion by a system of pulleys.

Cutting is allowed by abrasion phenomena between the wire and the material to be cut, optionally assisted by the action of a third body.

This method is further generally lubricated with a fluid such as water, polyethylene-glycol (PEG), a gel, etc.

Without any limiting intention, below the focus of interest is more specifically on the shaping of silicon for photovoltaic applications.

Wire saws are actually used in all the cutting steps applied for passing from an ingot to the substrates (or “wafers”) intended for manufacturing photovoltaic cells, i.e. successively:
squaring i.e. cutting the ingot into bricks with a normalized section;
cropping, which consists of removing the upper and lower portions of the bricks containing precipitates of impurities due to undesirable crystallization for the subsequent manufacturing steps;
cutting (“wafering” or “slicing”) of the bricks into substrates with a thickness ranging from 100 to 300 μm.

These successive operations are respectively illustrated in FIGS. 1A to 1C, the material to be cut being designated by the marking 200 and the cutting wire(s) being designated by the marking 102.

Optionally, the first two cutting steps (squaring and cropping) may be carried out without wire cutting, generally with a diamond wheel.

The wire cutting may be split up into two main categories according to the abrasion mode set into play.

A first type of cutting is the cutting with a free abrasive, wherein abrasive grains (often silicon carbide) are integrated into a solution (typically polyethylene-glycol (PEG)) forming a cutting liquid called a “slurry”.

The latter is poured between two solids sliding against each other (in this case, a steel wire on the material to be cut).

The abrasive grains are set into motion by sliding both bodies and abrade the material by multiple micro-indentations (rolling of the particles on the material).

This is a case of abrasion so-called “three body” abrasion (wire, abrasive grains, material).

The second type of cutting is the cutting with a bound abrasive, wherein abrasive grains (generally, diamonds whence the current name of “diamond wire cutting”) are attached on the surface of the wire and scratch the material to be cut out.

This is a case of abrasion so-called “two body” abrasion (abrasive wire, material).

Wire cutting with a bound abrasive, which is the preferred technique for cutting single crystal silicon, arrives on the market for silicon cutting for a photovoltaic application.

This technique actually has significant potential in terms of cutting performance as compared with the three body abrasion technique or with a free abrasive: cutting speeds two or three times greater, simplification of the technology of the saws, notably as regards the lubrication or the integration of a module for recycling the cutting residues.

As the cutting of the silicon represents about 10% of the production cost of a photovoltaic module, it is desirable to optimize this new technology.

The main obstacle to the development of the wire with a bound abrasive is its high cost—about a hundred times greater than that of the smooth wire used in the cutting with the slurry.

The lifetime of the wire with a bound abrasive is therefore one of the key parameters in order that this technology becomes cost-effective.

Indeed, a wire loses its capacity of removing material gradually during the cuttings.

This is expressed by the reduction in the cutting speeds: the wire penetrates more slowly into the material and becomes increasingly flexed. This may lead to a quasi-zero abrasion speed, if there is no breaking of the wire beforehand.

The manufacturers of wire with a bound abrasive quantify the lifetime of their products by a wire length in km per m² cut out (corresponding to the surface area of the section cut out by the wire).

This quantity mainly takes into account the loss in the maximum cutting speed acceptable by a wire, but remains an empirically determined datum.

In practice, it varies depending on the cutting parameters used (wire running speed, speed of its penetration into the material . . . ).

The replacement of the worn wire is therefore never optimized relatively to its actual wearing condition.

In the case of free wires (i.e. not looped), there moreover exists so-called “back & forth” conditions or round-trip conditions.

These conditions consist of unwinding the wire in one direction and then rewinding it in the other so that a point of the wire performs round trips on the material to be cut.

In most cases, there exists a mode such that at each cycle, a spool removes a certain length of worn wire and another replaces it with new wire for retaining good cutting capability (typically 5 meters for 100 meters of travel).

This adjustment is also carried out empirically and is very difficult to optimize systematically.

Moreover, the breakage remains substantially unpredictable.

The breakage may be ascribed to weakness of the wire, to the heterogeneities of the material to be cut or further to poor selection of the cutting parameters.

In particular, silicon for photovoltaic applications has inhomogeneities which may be classified according to two categories:
on the one hand, local defects (such as SiC or Si₃N₄ precipitates) with millimetric or submillimetric dimensions, which perturb the wire cutting, may cause breakage of the wire or generate streaks on the cut-out surface;
on the other hand, extended heterogeneities (i.e. of the order of several centimeters, or even about 10 cm) which are inherent to the method for crystallization of the ingots: first the existence of several grains (in the case of poly-crystalline silicon) with different orientations as well as of their boundaries, with properties hitherto poorly known, but also stress gradients or dislocation densities, variable concentrations of impurity precipitates between the top and the bottom of the ingot, as well as between its edges and its centre. These extended variations modify the mechanical properties of the material, and de facto its sawability.

Considering these inhomogeneities, it is presently difficult, or even impossible to define cutting parameters locally adapted to the cut-out material giving the possibility of reducing the wear of the wire and also its risks of breaking.

Other machining methods are subject to problems of wearing of the tool, notably grinders.

It was observed that the wear of the grinders has the consequence of increasing the cutting forces [1].

The increase in the cutting force with the wear of the wire has also been observed in the case of diamond wire cutting [2].

However, this general relationship cannot be utilized alone for reducing damaging of the wire, nor for adapting the method to the variable strength exhibited by the material.

Document US 2008/0065257 [3] proposes servo-control of the operation of a machining machine (notably the machine material throughput) to the cutting forces.

However, this method is not suitable for handling in real time the wearing rate of a wire and does not either allow optimization of the wire cutting according to the mechanical properties of the material to be cut.

Indeed, wire cutting, whether this is two or three body wire cutting, has specific technical problems, different from those encountered with so-called standard machining tools (grinder, milling machine . . . ):
During a cutting method, a wire naturally tends to be deformed when it enters the material. This deformation depends on parameters such as the wear of the wire, lubrication and/or the throughput of abrasive particles as well as the local resistance of the material to abrasion. The relationship between the actual cutting rates and the parameters of the method becomes non-linear and therefore more difficult to apprehend.
Wire cutting is an answer to a problem of generating surfaces in a given material, and not of removing a desired volume or of rectifying a shape like this is the case in most of the other machining modes.
In the case of wires with bound abrasives, the wear has substantially an impact at the scale of a cut and becomes a problem of first order, unlike that of the tools such as a milling machine or a turning tool. Further, the wearing mode of a wire with a bound abrasive is of a different nature since it is due to detachment and/or fracture of the diamonds and not to the blunting of a cutting edge.

The technical challenges of wire cutting are therefore distinct from those of the other machining modes.

Document CH 696 757 [4] discloses a method for wire cutting a material comprising a control loop of a cutting parameter, such as the advance speed or the speed of the wire, with a so-called control parameter. The control parameters considered in [4] are: the force for pressing the part to be sawed against the wire (parameter noted as P(z)), the pressure exerted by the part to be sawed on a wire (parameter F(z)), or the removal rate of material (parameter V(z)) which is proportional to the product of the pressure P(z) exerted by the part to be sawn on the wire and of the longitudinal speed of the wire.

However, this servo-control does not take into account the flexing of the wire during the cutting. Now, this flexing may have an influence on the quality of the cut and on the risk of breaking the wire.

An object of the invention is to allow optimization of the cutting speed according to the wear of the wire and to the resistance to abrasion exhibited by the material, notably when the latter is inhomogeneous.

An object of the invention is therefore to design a method (with a wire with bound abrasive or with a slurry) for wire cutting a material which allows reduction in the risks of breaking of the wire and in particular increase in the lifetime of the wire, in the case of a wire with bound abrasive.

### SHORT DESCRIPTION OF THE INVENTION

According to the invention, a method for wire cutting a material is proposed, wherein a cutting wire is advanced into said material by driving said wire into running so as to gradually cut the material, said method being characterized in that it comprises:
measuring a force applied by the wire onto said material versus time,
measuring the advance of the wire into said material versus time,
determining, from said force and said advance of the wire, a quantity characterizing the wire cutting condition, and
servo-controlling at least one cutting parameter to the time-dependent change of said quantity so as to decrease the wearing rate of the wire and/or reduce the risk of breaking the wire.

Wire cutting by spark-machining is not concerned by the present invention.

In the present text, by “wear of the wire” is meant the loss of its abrasive properties.

By “wear of the material” is meant the removal of material by abrasion of the cutout material.

By “advance of the wire” is meant the ratio between the cut-out section and the duration of the expressed cutting operation, either linearly by da/dt, or by the ratio between the surface generation rate dS/dt.

According to an embodiment, the advance of the wire is determined by the da/dt ratio, wherein a is the position of the wire with respect to one of the edges of the material over time.

In this case, the quantity EF characterizing the cutting condition fits the following formula:

$$EF = \frac{L}{Fu} \frac{d a}{d t}$$

wherein:

L is the width of the material to be cut,

F is the force measured, along the direction of the wire or preferably along the direction of the support of the material,

u is the running speed of the wire.

According to an embodiment of the invention, the advance of the wire is given by the formula:

$$\frac{d a}{d t} = V - \frac{d {y}_{0}}{d t}$$

wherein V is the speed of a kinematic system for guiding the wire with respect to the material and y₀ is the difference in position of the wire on an edge of the material with respect to said kinematic wire guiding system.

According to an embodiment, the advance of the wire is determined by the surface generation rate dS/dt, wherein S is the surface generated by the cutting in the material over time.

In this case, the quantity EF characterizing the cutting condition fits the following formula:

$$EF = \frac{L}{Fu} \frac{d S}{d t}$$

wherein:
F is the measured force,
u is the running speed of the wire.

According to an embodiment of the invention, the advance of the wire is given by the formula:

$$\frac{d S}{d t} = LV - L \frac{d {y}_{0}}{d t} ( 1 + \frac{L}{6 l} )$$

Wherein:
yₒ is the deflection of the wire on an edge of the material in the reference system of the kinematic wire guiding system,
L is the width of the material,
l is the distance between the edge of the material and the centre of rotation of the pulleys in a direction parallel to the wire.

Advantageously, the material is a semi-conducting material such as silicon and/or sapphire.

According to an embodiment of the invention, the cutting wire is a wire with a bound abrasive.

Said at least one cutting parameter servo-controlled to the time-dependent change of said quantity EF characterizing the cutting condition is selected from the running speed of the wire, the advance speed of the wire in the material and the renewal of the wire.

Advantageously, the method further comprises the servo-control of the distribution flow rate of a lubricant, of the wire tension and/or of the wire acceleration to the time-dependent change of said quantity EF characterizing the cutting condition.

Preferably, if the measured quantity EF becomes less than a predetermined threshold, the presence of a region with greater resistance to abrasion is detected in the material 200 and the servo-control comprises the reduction of the advance speed and/or the increase in the running speed of the wire 102 as long as the measured quantity EF remains below said threshold.

Conversely, if the measured quantity EF becomes greater than a predetermined upper limit, the presence of a region with lower resistance to abrasion is detected in the material 200 and the servo-control comprises the increase in the advance speed 102 while the quantity EF remains greater than said upper limit.

According to another embodiment of the invention, the cutting wire is smooth and the abrasion is produced by a cutting mixture comprising abrasive grains dispersed in a liquid, said mixture being dispensed between the wire and the material to be cut.

Preferably, said at least one servo-controlled cutting parameter is selected from the flow rate and/or the renewal rate of the cutting mixture.

Advantageously, the method further comprises the servo-control of the running speed of the wire, of the advance speed of the wire and/or the tension of the wire to the time-dependent change of said quantity EF characterizing the cutting condition.

Another object relates to a device for wire cutting a material, comprising:
a support for said material,
at least one cutting wire,
a kinetic wire guiding system, comprising at least two pulleys laid out for guiding said wire during the cutting of the material,
a control system suitable for controlling the running speed of the wire and the advance speed of the wire in the material.

Said device is characterized in that it comprises:
a device for measuring a force applied by the cutting wire on the material,
a device for measuring the advance of the wire,
a processing system configured for:
   determining from the measured force and advance of the wire, a quantity characterizing the wire cutting condition,
   monitoring the time-dependent change in said quantity over time,
   transmitting to the control system an instruction for servo-controlling at least one cutting parameter to the time-dependent change of said quantity, so as to decrease the wearing rate of the wire and/or reduce the risk of breaking the wire.

Advantageously, the force measurement device comprises at least one force sensor, preferably with a gauge.

According to an embodiment, said at least one force sensor is laid out against the support of the material, opposite to the cutting wire or on the kinematic wire guiding system.

The device for measuring the advance of the wire may also comprise an optical device, preferentially an infrared device, if the material to be cut is transparent to the corresponding wavelengths.

Alternatively or additionally, the device for measuring the advance of the wire comprises at least one position sensor, optionally a laser, capacitive and/or preferentially inductive sensor.

### SHORT DESCRIPTION OF THE DRAWINGS

Other features and advantages of the invention will become apparent from the detailed description which follows, with reference to the appended drawings wherein:

FIGS. 1A to 1C schematically illustrate the different steps for cutting silicon for a photovoltaic application;

FIG. 2 schematically illustrates an embodiment of a wire cutting device,

FIG. 3 schematically illustrates another embodiment of a wire cutting device,

FIG. 4 schematically shows the servo-control method;

FIG. 5 illustrates the time-dependent change of the quantity characterizing the wire cutting condition during the cutting of a homogenous material;

FIG. 6 illustrates the effect of renewal of the wire on the quantity characterizing the cutting condition during a cutting method under so-called “back & forth” conditions;

FIG. 7 illustrates the time-dependent change of the quantity characterizing the wire cutting condition during the cutting of a material having a heterogeneity.

### DETAILED DESCRIPTION OF THE INVENTION

### Cutting Device

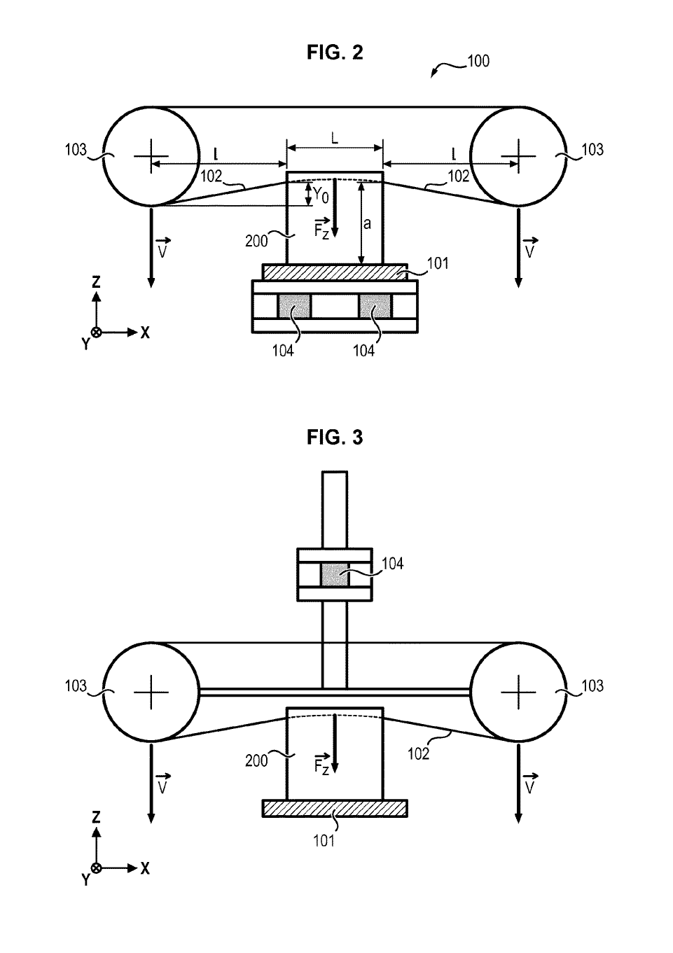

FIG. 2 schematically illustrates an embodiment of a wire cutting device.

Said device 100 comprises a support 101 for positioning and, if required, maintaining the material 200 to be cut, which is here represented as a parallelepipedal block.

However it is obvious that the material to be cut may have another shape without however departing from the scope of the invention.

Without the invention being limited to these materials, the material 200 to be cut is advantageously silicon, in particular silicon for a photovoltaic application, quartz or sapphire.

The material 200 is cut out by means of at least one cutting wire 102 which is driven so as to run in a direction parallel to the cutting line.

In the example illustrated here, the wire 102 forms a loop surrounding two pulleys 103 belonging to the wire guiding system which are laid out so as to guide the wire during the cutting of the material.

This embodiment is however not limiting and in an alternative embodiment, the wire may be free, i.e. it does not form any loop but is successively unwound on the side of one of the pulleys while being rewound on the side of the other pulley, so as to perform a reciprocal movement between said pulleys.

Moreover, the cutting wire is not necessarily unique; as this will be seen later on, the invention actually also applies to a wire web, i.e. to an assembly of strands which simultaneously cut the material, in a goal for productivity of the cutting method.

Said strands may consist of several loops or else of a single wire wound on two spools and having several strands in contact with the material to be cut.

The number of pulleys or wire guide 103 is not limited to two as illustrated here but may be adapted by one skilled in the art.

The pulleys are borne by a kinematic device (not shown) which gives the possibility of advancing them gradually during the cutting of the material, thereby allowing the wire to advance in the material. This device as well as the pulleys 103 is called a kinematic wire guiding system. This embodiment also is non-limiting, the wire guiding system may be fixed and the support of the material may be reciprocally guided towards the wire by means of a suitable kinematic system.

Conventionally, the material is cut along a vertical direction (i.e. along the z axis) and from top to bottom.

For this purpose, the wire guiding kinematic system comprising the pulleys 103 is driven in translation from top to bottom.

The relative advance velocity vector V of the pulleys 103 with respect to the material 200 is represented in FIGS. 2 and 3.

According to an embodiment, the wire 102 is a wire with a bound abrasive, for example a wire comprising a core, the surface of which is covered with a plurality of abrasive grains such as diamonds.

The abrasive grains may be secured to the core of the wire by means of a binding material.

From among the binding materials suitable for this use, mention may be made of metals (such as nickel or copper), polymers, or any other material ensuring the holding of the abrasive grains.

The diameter of the wire may be highly varied, but may typically be comprised between 60 μm and 2 mm.

Thus, for cutting silicon wafers for a photovoltaic application, the diameter of the wire is preferably comprised between 80 μm and 180 μm, still preferably between 100 μm and 160 μm.

For cropping and squaring, the diameter of the wire is typically comprised between 250 μm and 700 μm.

A lubricant is distributed between the wire 102 and the material 200 by means of an adequate device (not illustrated).

In a way known per se, the lubricant is a fluid such as water, polyethylene-glycol (PEG), a gel, etc.

According to another embodiment of the invention, the wire is smooth, the abrasion being produced by a “slurry”, i.e. a cutting mixture comprising abrasive grains dispersed in a liquid.

The device then comprises a device (not shown here) for dispensing said cutting mixture between the wire 102 and the material 200.

Moreover, the device 100 comprises a control system suitable for controlling the cutting parameters, including the running speed of the wire and the advance speed of the wire guiding system with respect to the material to be cut.

The running speed and the advance speed are actually cutting parameters which have an influence on the cutting performance and on the wear of the material.

As this will be seen later on, the invention provides servo-control of at least one cutting parameter so as to reduce the wearing rate of the wire, adjust the ratio between the cutting speed and the wear of the wire, or reduce the risk of breaking the wire.

For this purpose, the device 100 further comprises a device for measuring a force applied by the cutting wire 102 on the material 200.

The force F(t) exerted by the wire 102 over time in the normal direction to the wire (z axis of the reference system illustrated in FIG. 2) and/or in the direction tangent to the wire (x axis of the reference system illustrated in FIG. 2) is measured.

Preferably, the cutting force is measured along the z axis. This will therefore be referred in the subsequent text as a normal force F_{z}.

Advantageously but optionally, a measurement along the x axis and/or a measurement along the y axis are also used.

The force Fₓ along the axis x substantially and exclusively corresponds to the friction set into play.

According to Coulomb's law, the latter is therefore proportional to the normal force F_{z} and will have similar time-dependent change. Fₓ therefore almost bears the same information as F_{z}.

More specifically, from the measurement of the force along the x axis, it is possible to determine the normal force F_{z} by knowing the friction coefficient between the wire and the material under the cutting conditions.

Finally, the determination of the force along the axis y is secondary.

It gives the possibility of identifying lateral deviations of the wire and/or the presence of vibrations.

In order to measure said cutting force, one or several force sensors are used.

In the case of a single sensor, the latter is advantageously placed at right angles to the cutting line, i.e. in a plane parallel to the z axis and passing through the cutting line.

In the case of a plurality of sensors, the latter may advantageously be positioned at right angles to the cutting line or on the whole of the surface of the material to be cut.

In the embodiment of FIG. 2, two sensors 104 are advantageously positioned under the material 200, on the side opposite to the entry of the wire 102 in the material.

In the embodiment of FIG. 3, a sensor 104 is laid out on the kinematic wire guiding system comprising the pulleys 103.

The sensor(s) of the device for measuring a force may be directly sensitive to the force (like for example a piezoelectric sensor) or be based on the measurement of displacements from which the force may be inferred.

Piezoelectric sensors (notably with quartz) provide long lifetime, low congestion, large accuracy and a large range of measurements which are adapted to the invention.

However, the signals measured by such a technology may suffer from an intrinsic drift which makes these sensors less suitable for measurements on long cuts.

Piezoelectric sensors may therefore be used for short duration measurements (of less than 30 minutes, preferably less than 5 min), optionally reproduced during the cutting.

For servo-controls over longer durations, one or several sensors with stress gauges not subject to the latter phenomenon are used.

Said sensors will be selected with resonance frequencies distinct from the characteristic vibrations of the piece of equipment.

On the other hand, the time-dependent change in the penetration of the wire into the material to be cut is measured.

Therefore it is necessary to integrate to the cutting device, a device for measuring the advance of the wire in the material.

The advance of the wire gives the possibility of taking into account the deflection of the wire during the cutting of the material. This deflection results from the combination of many parameters including the diameter of the wire, its rigidity, the width of the material to be sawn, the tension of the wire, the gap between the wire guides, the force between the wire and the material, the speed of the table, the speed of the wire, the capability of the abrasives to abrade material and lubrication.

Thus, the advance of the wire is less than the advance of the wire guiding system or of the support of the material. In particular, the difference between the advance of the wire and that of the support (in the case when it is the support of the material which is moved towards the wire) is not negligible, especially at the beginning of cutting, and may be of more than 1 cm for a cutting distance of 15 cm.

As this deflection has a significant influence on the quality of the cut-out surfaces and on the risk of breakage of the wire, the measurement of the advance of the wire allows finer servo-control of the cutting parameters.

The advance of the wire may be defined by the velocity da/dt, a being the position of the wire at one of the edges of the material (cf. FIG. 2). a is for example the distance between the base of the material resting on the support 101 and the position of the wire on an edge of the material perpendicular to said base.

Several technical solutions exist for measuring the velocity da/dt:
Measurement of the shift in position of the wire yₒ on an edge of the material with respect to the kinematic wire guiding system (cf. FIG. 2).
The determination of the advance of the wire then requires the velocity V of the kinematic wire guiding system with respect to the material 200:

$$\frac{d a}{d t} = V - \frac{d {y}_{0}}{d t} \qquad ( 1 )$$

y₀ being the difference in position of the wire on an edge of the material with respect to the kinematic wire guiding system (cf. FIG. 2), i.e. the difference between the theoretical position of the wire if it was stretched in a rectilinear way between both pulleys 103 and the actual position of the wire, which is higher because of the deflection of the wire imposed by the material.
This solution is preferential in the case when V is known by the instrumentation of the saw since it requires a shorter measurement range and provides easier setting into place.
Measurement of the absolute position of the wire on an edge of the material with respect to a fixed point in the support of the material 200, directly giving da/dt.
This solution is satisfactory but requires a measurement range of the order of the height of the material and is subject to a more complex setting into place.

The position sensors may be inductive sensors, capacitive sensors, optical coders, mechanical probes, a video device, . . . .

Some of them are more or less adapted to the solutions listed earlier according to their measurement ranges and one skilled in the art will take into account the characteristics of these different sensors for selecting the sensor(s) to be applied.

Preferentially, the advance of the wire is defined by the surface generation rate dS/dt, S being the surface generated by the cutting at instant t. This measurement may be carried out in two ways:
a direct way, by measuring the actual deflection of the wire in the material. This is only possible for materials transparent to a certain spectrum like glass, quartz, sapphire or silicon (transparent to IR). This measurement therefore requires a video device.
an indirect way, by extrapolating a measurement of the position of the wire on an edge of the material as explained earlier. The generated surface may actually be determined by the following formula in the case of a symmetrical system:

$$\frac{d S}{d t} = LV - L \frac{d {y}_{0}}{d t} ( 1 + \frac{L}{6 l} ) \qquad ( 2 )$$

yₒ being the deflection of the wire on the edge of the material in the reference system of the kinematic wire guiding system,
L being the width of the material (by “width” is meant in the present text the dimension of the material parallel to the running of the wire), and
l being the distance between the axis x between the edge of the material and the center of rotation of the pulleys 103.

The device 100 further comprises at least one device for measuring time, such as a clock so as to determine the time-dependent change of the preceding quantities over time.

Moreover, the device comprises a processing system configured for:
determining, from the measured force and advance of the wire, a quantity EF characterizing the cutting condition, depending on the wear of the wire, and/or localized abrasion resistance of said material,
monitoring the time-dependent change of said quantity over time,
transmitting to the control system an instruction for servo-controlling at least one cutting parameter to the time-dependent change of said quantity, so as to decrease the wearing rate of the wire, adjusting the ratio between the ratio between the cutting rate and the wear of the wire, or reducing the risk of breaking the wire.

Typically, said processing system includes an acquisition chain connecting the device for measuring force and time to a processor on which is implemented an algorithm for driving the cutting device.

The processing system is connected to the control system so as to transmit instructions to it relating to one or several cutting parameters to be adjusted depending on the time-dependent change of the abrasion power.

FIG. 3 schematically illustrates another embodiment of a wire cutting device.

It differs from that of FIG. 2 by the fact that the force measurement device consists of a single force sensor 104 directly attached to the kinematic cutting wire guiding system.

Qualification of the Cutting Condition

The inventors used the measurements of the advancement of the wire as well as the measurements of cutting forces for establishing a quantity EF, called here an Efficiency Factor (EF) characterizing a wire cutting condition.

This quantity therefore in particular depends on the wear of the wire and/or on the localized abrasion resistance of said material, as well as on the deflection of the wire.

The monitoring over time of the quantity EF gives the possibility of servo-controlling at least one cutting parameter to it in order to optimize a method with respect to the global and local conditions.

This quantity provides two pieces of information which give the possibility of adjusting the cutting method:
the characterization of the instantaneous cutting power of the wire for a material, giving the time-dependent change of its wear. This gives a specific piece of information on the moment when the changing of the wire is required, on the one hand, a means for extending the lifetime of the wire on the other hand by adapting the cutting parameters (notably by automatic adjustment of the “back & forth” mode for the free wires),
a sudden change in this quantity is synonymous with a change in the mechanical characteristics of the cut material. The parameters of the cutting method may then be adjusted in order to optimize the cut (running speed, kinematic and dynamic speed of the wire with respect to the material).

It will be noted in an annex way that the sudden drop to a zero value of the force measurement along the z axis is synonymous with breakage of the wire during cutting, which is a non-obvious piece of information on industrial machines.

Obtaining the different pieces of information (wear, resistance of the material and breakage of the wire) from the measured raw signal is allowed by the differences in the characteristic durations set into play: the wear is a slow time-dependent change, while the changing of the material is rapid and/or discontinuous and the breakage is very fast, discontinuous and quantified.

By monitoring the quantity EF, it is therefore possible to optimize the cutting methods by automating the adjustment of the machine.

The inventors have shown that an advantageous and relevant form of the EF quantity may be written in the following way:

$$EF = \frac{L}{{F}_{z} u} \frac{d a}{d t} \qquad ( 3 )$$

with L the width of the material 200
F_{z} being the normal force applied by the wire 102 on the material 200
u being the sliding velocity of the wire
da/dt being the advance of the wire in terms of the time-dependent change velocity of the position of the wire at the edge of the material as defined earlier.

The inventors also recommend an even more advantageous and relevant form of the quantity EF by using the advance of the wire in terms of surface generation rate:

$$EF = \frac{L}{{F}_{z} u} \frac{d S}{d t} \qquad ( 4 )$$

with:
F_{z} is the normal force applied by the wire 102 on the material 200
u is the sliding velocity of the wire
dS/dt is the advance of the wire in terms of surface generation rate.

Case of a Web of Wires

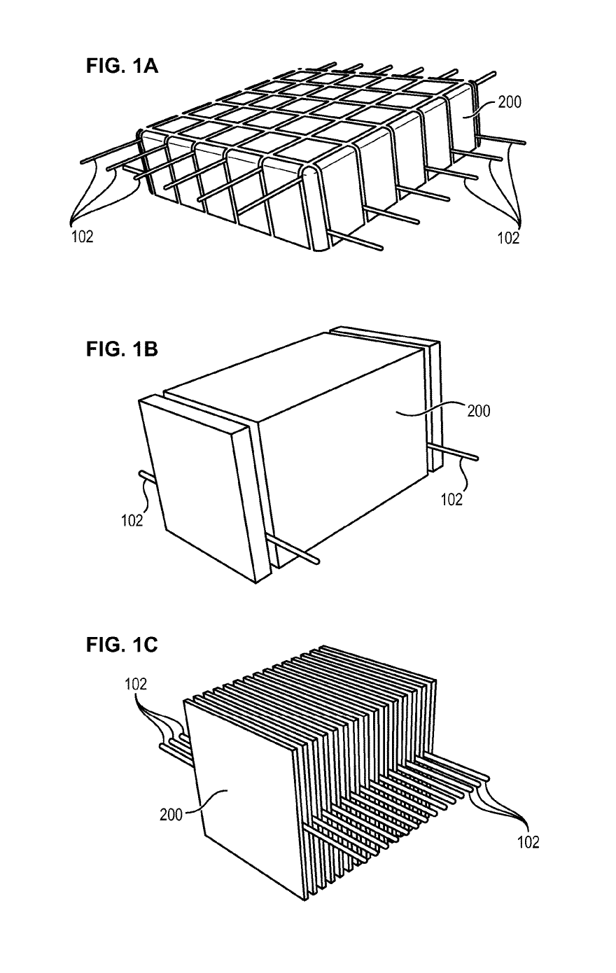

As mentioned above and for example illustrated in FIG. 1A, a cutting device is often equipped for a web of wires by which several strands simultaneously cut the material, in order to achieve a more productive cut.

In this case, the cutting force measured by the force measurement device is in fact the sum of the forces applied by each of the strands on the material to be cut.

It is therefore necessary in this situation to divide the force measured by the number of active strands—considered as a parameter of the cutting device—in order to obtain the force which a single strand applies.

The advance in the material of each strand may on the contrary be considered as equal from one strand to the other.

It is also possible to multiply this advance by the number of strands and to calculate the quantity EF directly considering the force measured by the force measurement device.

Both of these techniques are equivalent to applying formulae similar to the formulae (3) and (4), wherein n is the number of strands forming the web and F_{z} is the force along the z axis measured by the measurement device:

$$\begin{matrix}EF = n \frac{L}{Fz} \frac{d a}{d t} & ( 5 ) \\ EF = n \frac{1}{Fz} \frac{d S}{d t} & ( 6 )\end{matrix}$$

This quantity gives an average value of the wearing condition of the whole wire web.

It is also possible to have a localized value of the EF quantity by using several measurements of the advance of the wire with several position sensors. The force per strand is however always taken into account in the same way.

Servo-Control

The servo-control is based on the processing of information given by the time-dependent change of the EF quantity over time.

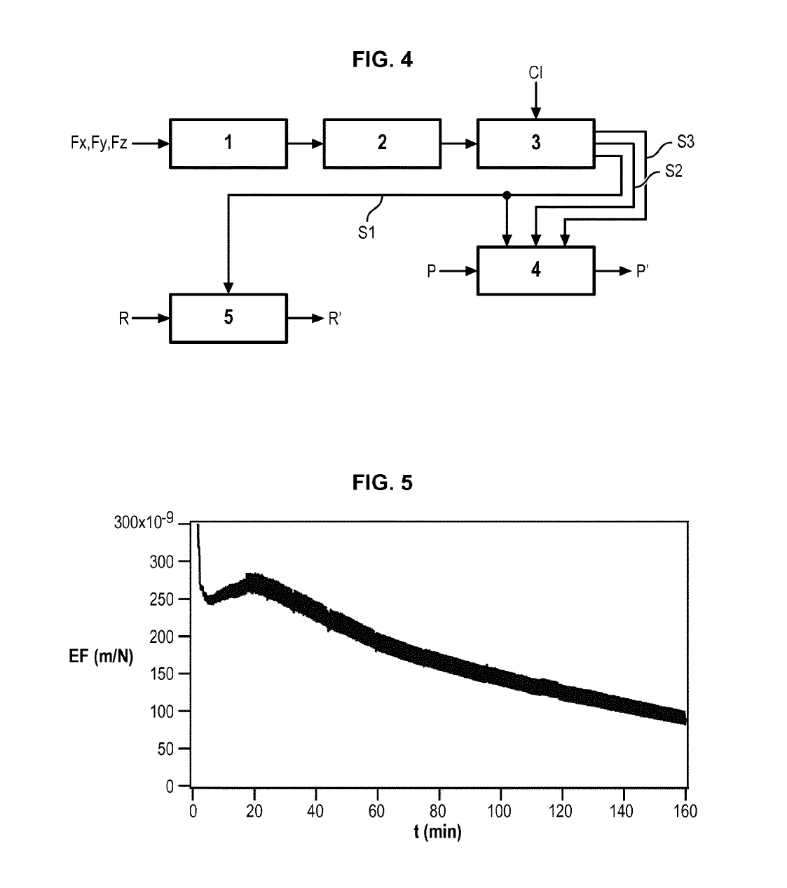

FIG. 4 illustrates in a simplified way the principle of the servo-control.

The block 1 relates to the measurement which is applied by the force measurement device comprising at least one force sensor and by the device for measuring time.

The block 2 relates to the acquisition of said measurements and the transfer of the acquired data to a processor on which is implemented the driving algorithm.

The block 3 relates to the processing of the data by the driving algorithm, the determination of the EF quantity and the deduction of phenomena which may influence the wear or the risk of breaking the wire.

Moreover, the driving algorithm receives as input data CI instructions from the operator and pieces of information on the nature of the material and of the cutting wire.

The driving algorithm may provide the following output data:

s1: either breakage or not of the wire

s2: wear condition of the wire

s3: abrasion resistance of the material.

Block 4 relates to the optimization and to the adaptation of the cutting parameters by taking into account these data and present cutting parameters. This block receives at the input the present cutting parameters (noted as P) and provides at the output the optimized cutting parameters P′.

This operation is carried out with control electronics forming part of the control system.

Finally, block 5 relates to the application of an alert when the breakage of the wire is detected. For example, this block transforms a piece of breakage information R initially deactivated into an activated breakage piece of information R′ if breakage of the wire is detected.

For this purpose, the control system may comprise a user interface allowing visual display of an alert signal, a sound device or any other means giving the possibility of informing an operator on the breakage of the wire.

Advantageously but optionally, the force measurements along the y axis are used for determining the vibrations of the cutting device and accordingly adapting at least one cutting parameter.

Detection of a Worn Wire

In the case of a looped wire, the detection of the instant when the quantity EF passes a wear threshold defined beforehand according to the nature of the wire used allows determination of the instant when the wire has to be replaced, by an operator or in an automated way.

Typically, it may be considered that a wire is out of order if the quantity EF is less than its initial value by 30 to 60%. FIG. 5 shows the time-dependent change of the EF quantity over time for a given method and thus an example of the time-dependent change in the wear of a wire.

Controlling the Lifetime of the Wire

Advantageously, servo-control may be applied in order to modulate the advance velocity of the wire as well as its running speed in order to control or reduce the degradation rate of the wire in its place.

According to an advantageous embodiment of the invention, this modulation may also relate to the lubrication, notably by the increase or the decrease in the spraying flow rate depending on the degree of wear of the wire.

These adjustments may be made from abaci of the time-dependent change in the EF quantity recorded beforehand.

As an example, the inventors have shown that by reducing the running speed of the wire, it is possible to increase the lifetime of a wire with embedded diamonds.

Industrially, the optimization of the cutting parameters may integrate the cost associated with the cutting time (which notably depends on the desired throughput and on the piece of equipment used) and the cost of the wire, in order to obtain a compromise between the number of cut parts and the period of use of a wire.

The invention then allows control and preservation of the lifetime of the wire.

Detection of the Breakage of the Wire

The device also allows easy detection of the breakage of the wire.

Indeed, this breakage is expressed by a sudden drop of the measured cutting force in the vicinity of zero.

An advantageous mode of the servo-control may therefore process this information.

It is then possible to control stopping of the cutting device (for example, stopping the rotation of the motors, etc.), and/or wind up the guiding device supporting the pulleys.

This gives the possibility of avoiding the causing of damages on the material to be cut and/or on the actual cutting device if the latter continued to rotate with no load.

“Back & Forth” Conditions

In the case of free wires, two so-called “back & forth” (round-trip) are distinguished.

Indeed, there exist complete round-trip conditions, i.e. the same length of wire is unwound on one side as rewound on the opposite side.

In this case, the servo-control described above for the looped wires is applied in a similar way to the free wires.

Moreover there exist round-trip conditions with partial renewal of the wire, in which a wire portion is removed at each cycle and replaced with a new wire portion.

In this configuration, it is possible to servo-control the cutting so as to adjust the amount of removed wire by defining as a set value a constant EF quantity interval or a constant cutting force interval.

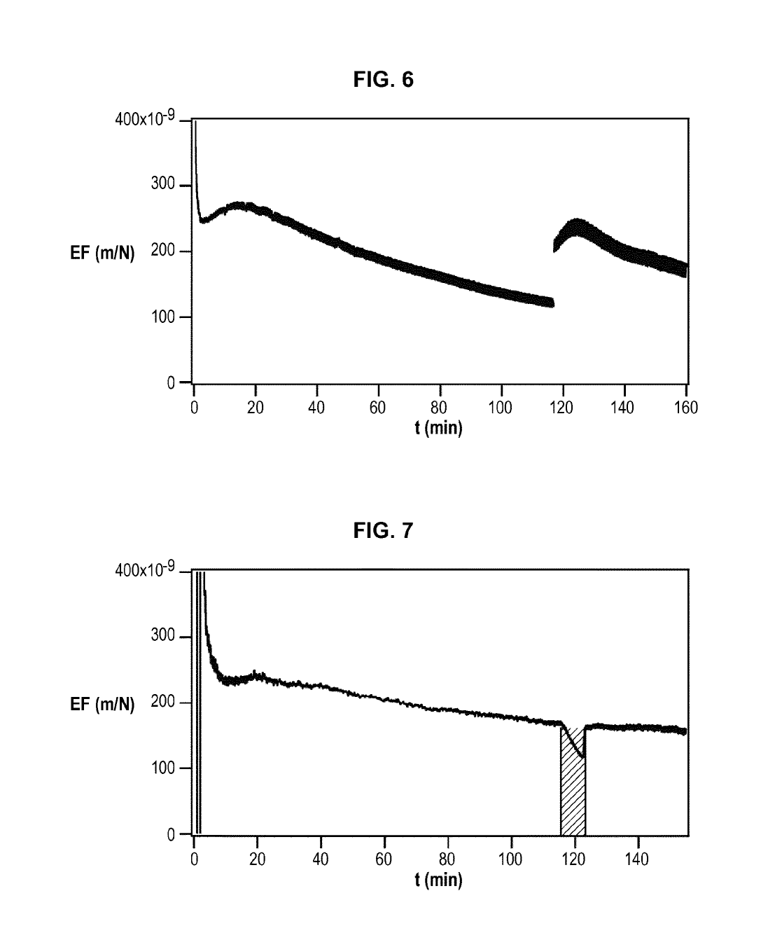

FIG. 6 illustrates the result of such a servo-control, wherein the EF quantity time-dependently changes in a cyclic way between two limits.

Indeed, too frequent renewal of the wire induces an excessive consumption of wire.

On the contrary, too low renewal of wire (i.e. a too seldom replacement or of an insufficient length) would lead to a decrease in the desired cutting speed.

A servo-control consisting of adjusting the renewal of the wire in order to retain a constant average value EF over one cycle (or several representative successive cycles) therefore allows wire savings while optimizing the cutting capability of the device.

Adaptation to the Inhomogeneities of the Cut Material

The adaptation of the cutting parameters according to the mechanical characteristics of the material may be directly carried out by processing the measurement of the cutting forces, notably with that of the force normal to the wire.

FIG. 7 thus illustrates an example of the time-dependent change of the quantity EF, calculated according to one of the formulae (3) or (4), for an inhomogeneous material locally comprising an area having a higher abrasion resistance than the average resistance of the material, for example due to a precipitate of impurities.

During the encounter of the wire with such a more resistant area (illustrated by the hatched area in FIG. 7), the quantity EF sharply decreases.

Conversely, in the case (not shown) when the material locally comprises an area having a lower abrasion resistance than the average resistance of the material, it is observed on the curve of the time-dependent change of EF over time that this quantity sharply increases.

The device is therefore able to detect a change in the mechanical properties of the cut material.

In such a situation, the servo-control gives the possibility of reducing, or even stopping the advance of the pulleys, and increasing the running speed of the wire so that the force is again reduced for returning to an expected time-dependent change in the force.

Thus, the servo-control gives the possibility of relieving the stresses to which the cutting wire is subject during the cutting of a heterogenous material, thereby reducing its wear and its risk of breaking while optimizing the cutting thereof.

Case of the Wire Cutting with a Slurry

Although the preceding description is more particularly aimed at wire cutting with a bound abrasive, servo-controlling at least one cutting parameter to the abrasion power may also be applied in wire cutting with a slurry.

In such a case, the wire is smooth while abrasive grains are dispersed in a cutting liquid, thereby forming a mixture called a “slurry”, which is distributed at the cutting line.

In this situation, the servo-control gives the possibility of regulating the abrasive flow rate and thus optimize the cutting.

As discussed earlier, the cutting force, the advance of the wire are measured, a quantity EF characterizing the cutting condition is determined, and at least one cutting parameter is server-controlled.

A too fast decrease in the quantity EF may be corrected by increasing the slurry flow rate.

A slow decrease in the quantity EF (i.e. a continuous decrease over several hours) expresses degradation of the slurry, mainly a reduction in the size of abrasive grains and/or an increase in the proportion of turnings of the cut material in the cutting liquid.

This situation may be remedied by renewing the slurry.

### REFERENCES

[1] K. Fathima; A. Senthil Kumar; M. Rahman; H. S. Lim, A study on wear mechanism and wear reduction strategies in grinding wheels used for ELID grinding, Elsevvier Science: Wear, Vol. 254, 2003
[2] W. I. Clark; A. J. Shih; R. L. Lemaster; S. B. McSpadden, Fixed abrasive diamond wire machining—Part II: experiment design and results, International Journal of Machine Tools & Manufacture, ed. 43th, 2003
[3] J. He; H. Zhang; Z. Pan, Controlled material removal rate (CMRR) and self-tuning force control in robotic machining process, US Patent Application Publication, n ° US 2008/0065257 A1, 2008
[4] CH 696 757

1. A method for wire cutting a material, in which a cutting wire is advanced in said material by causing said wire to run so as to gradually cut the material, the method comprising:
measuring a force applied by the wire on said material versus time,
measuring the advance of the wire in said material versus time,
determining, from said force and from said advance of the wire, a quantity characterizing the wire cutting condition, and
servo-controlling at least one cutting parameter to the time-dependent change of said quantity so as to decrease the wearing rate of the wire and/or reducing the risk of breaking the wire.

2. The method according to claim 1, wherein the advance of the wire is determined by the ratio da/dt, wherein a is the position of the wire with respect to one of the edges of the material versus time.

3. The method according to claim 2, wherein the quantity characterizing the cutting condition fits the following formula:
$$EF = \frac{L}{Fu} \frac{d a}{d t}$$
wherein:
L is the width of the material to be cut,
F is the measured force,
u is the running speed of the wire.

4. The method according to claim 3, wherein the advance of the wire is given by the formula:
$$\frac{d a}{d t} = V - \frac{d {y}_{0}}{d t}$$
wherein V is the velocity of a kinematic wire guiding system with respect to the material and y₀ is the difference in position of the wire on an edge of the material with respect to said kinematic wire guiding system.

5. The method according to claim 1, wherein the advance of the wire is determined by the surface generation rate dS/dt, wherein S is the surface generated by the cutting in the material over time.

6. The method according to claim 5, wherein the quantity characterizing the cutting condition fits the following formula:
$$EF = \frac{L}{Fu} \frac{d S}{d t}$$
wherein:
F is the measured force,
u is the running speed of the wire.

7. The method according to claim 6, wherein the advance of the wire is given by the formula:
$$\frac{d S}{d t} = LV - L \frac{d {y}_{0}}{d t} ( 1 + \frac{L}{6 l} )$$
Wherein:
yₒ is the deflection of the wire on the edge of the material in the reference system of the kinematic wire guiding system,
L is the width of the material,
l is the distance in a direction parallel to the wire between the edge of the material and the centre of rotation of the pulleys.

8. The method according to claim 1, wherein the material is a semi-conducting material such as silicon and/or sapphire.

9. The method according to claim 1, wherein the cutting wire is a wire with a bound abrasive.

10. The method according to claim 1, wherein said at least one cutting parameter servo-controlled to the time-dependent change of said quantity characterizing the cutting condition is selected from the running speed of the wire, the advance velocity of the wire in the material and the renewal of the wire.

11. The method according to claim 10, further comprising servo-control of the distribution flow rate of a lubricant, of the tension of the wire and/or of the acceleration of the wire to the time-dependent change of said quantity characterizing the cutting condition.

12. The method according to claim 3, wherein if the measured quantity becomes less than a predetermined threshold, the presence of a region with greater abrasion resistance is detected in the material and the servo-control comprises the reduction in the advance speed and/or the increase in the running speed of the wire as long as the measured quantity remains below said threshold.

13. The method according to claim 3, wherein if the measured quantity becomes greater than a predetermined upper limit, the presence of a region with lower abrasion resistance is detected in the material and the servo-control comprises the increase in the advance speed as long as the quantity remains above said threshold.

14. The method according to claim 1, wherein the cutting wire is smooth and the abrasion is achieved by a cutting mixture comprising abrasive grains dispersed in a liquid, said mixture being dispensed between the wire and the material to be cut.

15. The method according to claim 14, wherein said at least one servo-controlled cutting parameter is selected from among the flow rate and/or the renewal rate of the cutting mixture.

16. The method according to claim 15, further comprising servo-control of the running speed of the wire, of the advance speed of the wire and/or the tension of the wire to the time-dependent change in said quantity characterizing the cutting condition.

17. A device for wire cutting a material, comprising:
a support for said material,
at least one cutting wire,
a kinematic system for guiding the wire, comprising at least two pulleys laid out for guiding said wire-during the cutting of the material,
a suitable control system for controlling the running speed of the wire and the advance speed of the wire in the material,
a device for measuring a force applied by the cutting wire onto the material,
a device for measuring the advance of the wire,
a processing system configured for:
determining from the measured force and wire advance, a quantity characterizing the wire cutting condition,
monitoring the time-dependent change in said quantity over time,
transmitting to the control system an instruction for servo-controlling at least one cutting parameter to the time-dependent change in said quantity so as to decrease the wearing rate of the wire and/or reduce the risk of breaking the wire.

18. The device according to claim 17, wherein the force measurement device comprises at least one force sensor, preferentially a force gauge.

19. The device according to claim 18, wherein said at least one force sensor is laid out against the support of the material, opposite to the cutting wire or on the kinematic wire guiding system.

20. The device according to claim 17, wherein the device for measuring the advance of the wire comprises an optical device, preferentially an infrared device.

21. The device according to claim 17, wherein the device for measuring the advance of the wire comprises at least one position sensor, optionally a laser, capacitive and/or preferentially inductive device.

22. The method according to claim 6, wherein if the measured quantity 6 becomes less than a predetermined threshold, the presence of a region with greater abrasion resistance is detected in the material and the servo-control comprises the reduction in the advance speed and/or the increase in the running speed of the wire as long as the measured quantity remains below said threshold.

23. The method according to claim 6, wherein if the measured quantity becomes greater than a predetermined upper limit, the presence of a region with lower abrasion resistance is detected in the material and the servo-control comprises the increase in the advance speed as long as the quantity remains above said threshold.
